(19) United States
(12) Patent Application Publication
(10) Pub. No.: US 2021/0335117 A1
(43) Pub. Date: Oct. 28, 2021

(54) GAS DETECTOR SYSTEMS AND METHODS FOR MONITORING GAS LEAKS FROM BURIED PIPELINES

(71) Applicants: Colorado State University Research Foundation, Fort Collins, CO (US); The Board of Regents, University of Texas System, Austin, TX (US)

(72) Inventors: Gerald Patrick Duggan, Fort Collins, CO (US); Kathleen Maron Smits, Southlake, TX (US); Riley DeWitt Ancona, Broomfield, CO (US); Younki Cho, Dallas, TX (US)

(21) Appl. No.: 17/232,391

(22) Filed: Apr. 16, 2021

Related U.S. Application Data
(60) Provisional application No. 63/013,667, filed on Apr. 22, 2020.

(51) Int. Cl. G08B 21/16; G08B 25/08; G01M 3/18; G01S 19/01

(52) U.S. Cl. CPC G08B 21/16; G01S 19/01; G01M 3/18; G08B 25/085

(57) ABSTRACT

Gas monitoring network and deployment systems and methods are described for detecting gas leaks (e.g., natural gas leaks) from gas infrastructures (e.g., buried natural gas) within residential, commercial, rural, and industrial areas. A method of deployment involves placing detector systems indoor and outdoor environments in distinct patterns, providing early warning or long-term monitoring of gas leaks via data communication technologies.

### CROSS-REFERENCE TO RELATED APPLICATIONS

This application claims the benefit of U.S. provisional patent application No. 63/013,667, filed on Apr. 22, 2020, and entitled “Methane Detector Network for Monitoring Natural Gas Leaks from Buried Pipeline,” the disclosure of which is expressly incorporated herein by reference in its entirety.

### GOVERNMENT SUPPORT CLAUSE

This invention was made with government support under 693JK31810013 awarded by the U.S. Department of Transportation. The government has certain rights in the invention.

### FIELD

The disclosure generally relates to gas monitoring network and deployment systems and methods for detecting underground gas leaks within residential, commercial, rural, and industrial areas.

### BACKGROUND

Natural gas (NG) pipeline safety has greatly improved in recent decades. Nevertheless, leakage incidents still occur, oftentimes associated with aging infrastructure, excavation, and human error. Pipeline leakage can be catastrophic due buildup and migration though subsurface environments and ultimately its release into the air or a substructure (e.g., basement, French drains, sewer lines, etc.).

Although recent technology advances in methane detection have improved leak detection and repair, efforts are hampered in subsurface pipeline scenarios due to the complex nature and extent of such leaks. Soil layers and other subsurface infrastructure above and around a leaking pipeline markedly affect subsurface NG migration. In addition, gas composition and pipeline pressures also play a vital role in the NG migration from its point source. Surface conditions such as pavements or homes (e.g., basements and crawlspaces) also create barriers to gas flow and release to the atmosphere, resulting in lateral transport or in some cases accumulation below ground. NG migration is also affected by pressure differentials which can be developed because of short-term fluctuations in barometric pressures due to natural oscillations of atmospheric wind, meteorologically induced long-term changes in barometric pressures, and water table fluctuations due to site specific hydrogeology or rainfall events.

Once a leak is detected, further investigation determines the significance of the leak, known as the leak's “grade”. The leak is graded a Type 1, 2, or 3 leak, depending on the probable hazard to persons or property. Although the exact definition of Type 1-3 leaks varies based on state requirements, in general, a Grade 1 leak, also referred to as a “hazardous leak” is a gas leak that poses an existing or probable hazard to persons or property and requires immediate action (usually immediate repair). Grade 2 leaks are generally recognized as non-hazardous to people or property at the time of detection but do require periodic surveillance and scheduled repair. State regulations vary but in general, a Grade 2 leak is required to be fixed within 12-15 months from the date of detection/report. Grade 3 leaks can remain open for long periods of time. They require reevaluation during the next scheduled survey (approximately 6 months), or within 15 months of the date reported, whichever occurs first, until the leak is re-graded or no longer results in a reading. Although practices are in place to reevaluate existing leaks, current guidance relies on reevaluation during regular survey periods which depending on the size of the utility, can be every 6 months to one year.

A major concern of natural gas detection and repair teams is the potential for the conditions of a gas leak to worsen over time, resulting in a leak “upgrade.” For example, a Grade 3 leak may be upgraded to a Grade 2 leak during the long delay between detection and repair. Change in a leak's significance can occur due to many factors including competing utility or construction work in the area, variations in soil conditions, changes in surface structure, etc. This is especially pertinent in urban areas. Due to this potential for a change in the leak behavior as well as the long times in-between leak reevaluation, there is an urgent need for an ability to remotely monitor existing gas leaks over time. This would allow for an understanding of any change in gas concentration, indicating a potential change in the leak size or location. Gas sensors would be ideally installed on the soil surface around the suspected leak location or within bar holes to capture the aboveground and belowground gas concentrations. Current technologies are not available to meet this need.

There are currently several types of indoor natural gas detectors. These detectors notify occupants, usually with an alarm, when the gas concentration exceeds a predetermined threshold. Some detectors are connected to a central monitoring station and notify first responders and/or the local gas utility when an alarm is triggered, such as the smart natural gas detector. However, this detector is only applicable for indoor environments. Type 2 and 3 leaks are usually 5 and 25 feet from a structure, respectively. Available stationary outdoor detectors are traditionally implemented for outdoor air quality monitoring. They are mainly designed for high accuracy and coarse spatial resolution (i.e., only a few sensors installed) due to the high costs of installation and maintenance.

Portable stationary detectors have recently emerged using low-cost sensor platforms to enhance spatial resolution and reduce costs of the instrument. Common techniques used in the low-cost sensors are metal oxide semiconductor (MOS), electrochemical (EC), non-dispersive infrared radiation (NDIR), and photo ionization detection.

A metal oxide semiconductor sensor measures changes in electrical resistance of sensor when the sensor is exposed to a target gas. Adsorption of target gas molecules on the semiconductor surface allow electrons to flow easily, resulting reduction in the electrical resistance. The resistance is correlated to the concentration of the target gas. Interference is observed from changes in humidity, pressure, and temperature. Frequent calibration is recommended.

EC sensors measure the electrical current generated by electrochemical reaction when an electrolyte is in contact with a target gas. The measured current corresponds to the gas concentration. The EC sensor typically consists of three electrodes: (1) working, (2) counter, and (3) reference. The working electrode oxidizes or reduces the target gas and generates an electric current. Electronic charge generated by the reaction at the surface of the working electrode is balanced by a reaction at the counter electrode. The reference electrode ensures that the working electrode performs properly. The electrolyte can be liquid, gaseous, gel or solid. The performance of the electrochemical sensor is influenced by humidity, pressure, and temperature, similar to the metal oxide semiconductor sensors.

A non-dispersive infrared radiation sensor measures the intensity of the infrared radiation passing through narrow absorption band. The sensor typically consists of a light source, gas chamber, and a detector. The intensity of the infrared radiation is proportional to the concentration of the target gas. The NDIR sensor is compact and stable to changing temperature and humidity, but the calibration can be misinterpreted.

A photo ionization detector sensor measures electrical current produced by the absorption of a photon when the target gas is illuminated under UV light. The electrical current corresponds to the gas concentration. The sensor is influenced by humidity and temperature, but it is stable to changes in pressure. Although the ionization detector is relatively stable, it requires frequent calibration.

Even though the abovementioned detectors are commercially available they are not practical for use in monitoring systems for pipeline gas leakage due to cost, data accessibility, deployment method, and integration of data gathered from multiple locations.

There is a need for a continuous real-time monitoring detector network to improve the efficiency of surveys, improve reliability of gas concentration data, and provide continuous surveillance of potentially hazardous areas, and provide early warning.

It is with respect to these and other considerations that the various aspects and embodiments of the present disclosure are presented.

### SUMMARY

Gas monitoring network and deployment systems and methods are described for detecting gas leaks (e.g., natural gas leaks) from gas infrastructures (e.g., buried natural gas) within residential, commercial, rural, and industrial areas. A method of deployment involves placing detector systems indoor and outdoor environments in distinct patterns, providing early warning or long-term monitoring of gas leaks via data communication technologies.

In an implementation, a system comprises: a central computing device; and a plurality of gas detectors deployed in a geographic region, wherein each of the plurality of gas detectors is configured to sense real-time data and transmit the real-time data to the central computing device.

In an implementation, a method comprises: deploying a plurality of gas detectors deployed in a geographic region, wherein the geographic region comprises a gas pipeline, an environment with a known existing leak, or a high-risk area; sensing real-time data with the plurality of gas detectors; and transmitting the real-time data to a central computing device.

In an implementation, a method comprises: receiving, over a network at a computing device, real-time data from a plurality of gas detectors deployed in a geographic region; storing the real-time data in storage associated with the computing device; analyzing the real-time data to determine whether to generate at least an alert or other information based on the real-time data; generating at least the alert or other information based on the real-time data, responsive to the analyzing; and providing the at least the alert or other information to at least one recipient.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for detecting and monitoring gas leaks;

FIG. 2 is an illustration of a component layout of an implementation of a detector;

FIG. 3 is an illustration of a schematic diagram of an implementation of a real-time monitoring network at a known leak area;

FIG. 4 is an operational flow of an implementation of a method for gas leak detection and monitoring;

FIG. 5 is an operational flow of another implementation of a method for gas leak detection and monitoring; and

FIG. 6 shows an exemplary computing environment in which example embodiments and aspects may be implemented.

### DETAILED DESCRIPTION

This description provides examples not intended to limit the scope of the appended claims. The description is not to be taken in a limiting sense, but is made merely for the purpose of illustrating the general principles of the invention, since the scope of the invention is best defined by the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Various inventive features are described herein that can each be used independently of one another or in combination with other features.

As described further herein, detectors, such as methane detectors, may be widely deployed to establish a network at the locations of the known leaks or high-risk areas, and the network can play a vital role in safeguarding against hazards by providing continuous real-time monitoring. Integration of data from a network of multiple detectors allows for the monitoring of migration and accumulation of natural gas. Moreover, the network of multiple detectors can be used to provide early warning of a leak or to monitor an existing leak to ensure that it does not change.

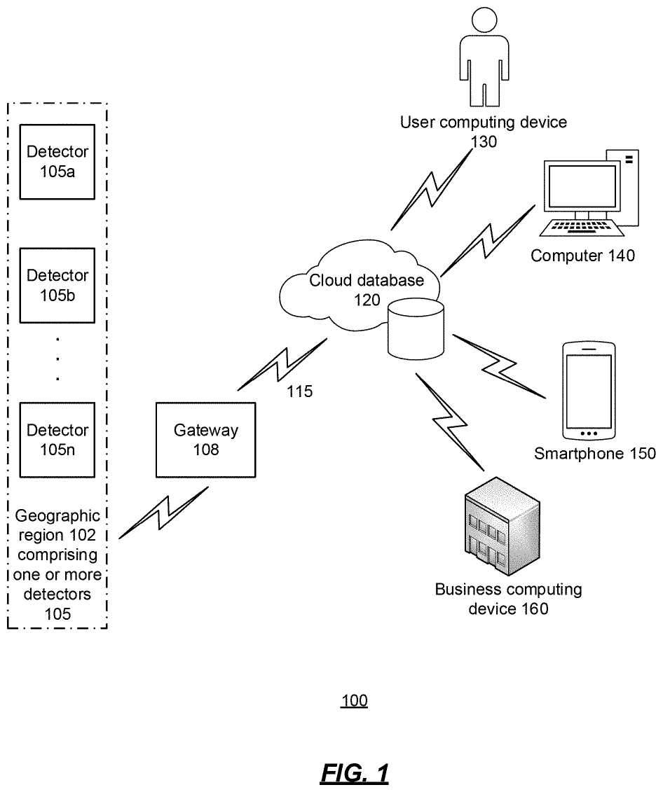

FIG. 1 is an illustration of an exemplary environment 100 for detecting and monitoring gas leaks.

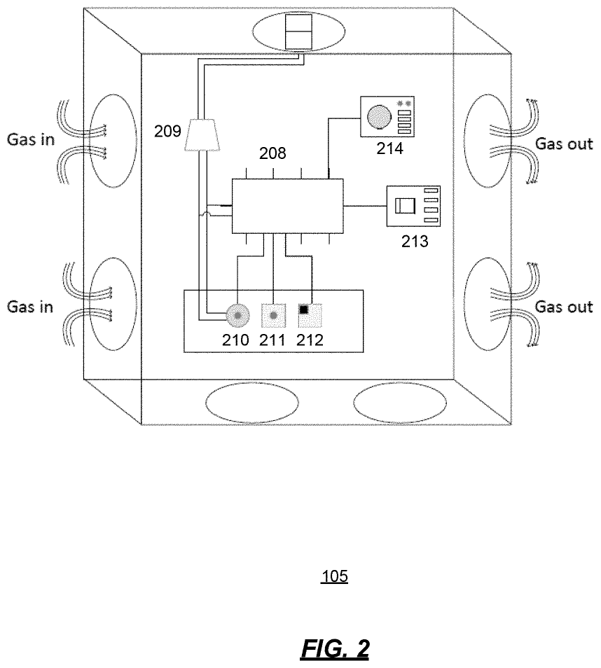

The environment 100 may include one or more detectors 105 (shown as detector 105a, 105b, . . . 105n) located (i.e., deployed) in a geographic region 102. The detectors may be any type of gas detector depending on the implementation. In an implementation, each detector 105 is a methane detector, and may be powered by an AC/DC adapter or other power source such as a battery, for example. In an implementation, described further with respect to FIG. 2 for example, each detector 105 may include a microcontroller with built-in Wi-Fi connection, a Global System for Mobile Communications (GSM) module, a natural gas sensor, a temperature/relative humidity sensor, and a pressure sensor. The system can be constructed using commercially available parts that are sold separately. Other implementations may use LoRa, Bluetooth, a local WiFi connection, etc. Any known back-end technology may be used, depending on the implementation.

With respect to the back-end (e.g., a node-node communications network), the detectors 105 may be in communication over a gateway 108 to a front-end network. With respect to the front-end, the detectors 105 may be in communication with a cloud database 120 (e.g., via a detectors to cloud network 115). In an implementation, the front-end uses a connection to the cloud, such as the public switched telephone network (PSTN), a cellular telephone network, and a packet switched network (e.g., the Internet). In an implementation, the back-end may use low-latency, low-bandwidth networking technology (e.g., the typical message size will be less than 256 bytes) such as WiFi, LoRa, 802.15.4/Zigbee, etc.

In some implementations, the functions of the front-end and the back-end may be merged.

The cloud database 120 may be in communication through one or more networks with one or more entities, such as a user computing device 130 (e.g., a computing device of a first responder), a computer 140, a smartphone 150 (e.g., of an occupant of a home or building), and/or a business computing device 160 (e.g., a computing device of a gas utility company). Each network may be a variety of network types including a wireless local area network, the public switched telephone network (PSTN), a cellular telephone network, and a packet switched network (e.g., the Internet).

Any number of detectors 105 may be supported. In some implementations, each of the detectors 105 may include a Global Positioning System (GPS) chip so that the location of each detector may be determined along with the time of day. Other implementations may use timestamping of messages as they arrive at the gateway 108, and that timestamp may be used to determine reading timing. The detectors 105 may synchronize their times so that they can agree on the time to millisecond accuracy, although this is not intended to be limiting. In some implementations, some or all of the detectors 105 can communicate with one another, e.g., over a network. Each detector 105 may have analytic capabilities with their own data and/or with data from other detectors.

Moreover, although only one cloud database 120, one user computing device 130, one computer 140, one smartphone 150, and one business computing device 160 are shown in FIG. 1, there is no limit to the number of cloud databases 120, user computing devices 130, computers 140, smartphones 150, and business computing devices 160 that may be supported.

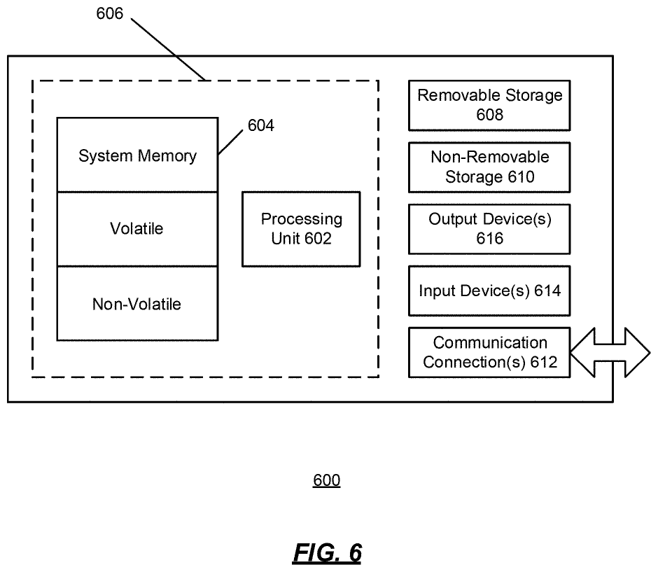

The cloud database 120, the user computing device 130, the computer 140, the smartphone 150, and the business computing device 160 may be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 6 as the computing device 600.

In an implementation, the environment 100 may comprise a low-cost, real-time natural gas monitoring detector network along with methods of deployment for both indoor and outdoor applications. Each detector 105 may comprise a system of sensors to collect real-time (e.g., every one second, every one minute, every five minutes, every one hour, etc.) data and communicate this data (e.g., gas concentration, time, location, etc.) to the cloud database 120, and/or other entities, such as first responders (e.g., via the user computing device 130), utility companies (via the business computing device 160), etc.

Thus, in an implementation, the cloud database 120 (which may be associated with, or comprise, a central computing device or other computing device depending on the implementation) collects natural gas concentration levels from each detector 105 via the internet for a first responder (e.g., via the user computing device 130), a gas utility company (via the business computing device 160), and a dweller (e.g., via the computer 140 or the smartphone 150) to take appropriate action on.

In an implementation, NG detectors are deployed in a dense network to measure local level gas concentrations and monitor changes to gas behavior over time. Network configurations vary with location/need to include residential, commercial, rural, and industrial areas. Deployment options include (1) if there is a known existing leak that requires long term monitoring (outdoor environment) and (2) a location inside or outside in a high-risk area requiring monitoring (e.g., apartment basement in a historically high leakage area).

The detector 105 is applicable for indoor and outdoor environments. For indoor applications, the detector 105 can be installed near gas appliances or in basement. Methane concentration, pressure, temperature, and relative humidity are measured. The measurement data are transmitted from the detector 105 to a cloud database (such as the cloud database 120) over a wireless local area network or cellular network. The collected data are stored on a server and always available via the internet, accessible by any computer. A gas company uses a cloud database software system to manage the collected data. In the event of a gas leak, the detector triggers an alarm for evacuation, and the software system notifies first responders and contact occupants by telephone call, SMS text messaging, or email. The utility company dispatches service technicians to respond to the gas leak.

There are no technologies currently available that can be used as a network of portable stationary detectors for real-time monitoring at remote areas. This system can be used in wide variety of sites to include known leak locations and high-risk areas. Gas concentration over time may be monitored. The migration of gas may be detected based on the readings over time on various detectors in a network of detectors in a geographic region.

FIG. 2 is an illustration of a component layout of an implementation of a detector 105. In an implementation, electric components are enclosed in a waterproof box to protect from rain and water splash back. The detector 105 has two power options in some implementations: AC/DC adapter and external battery.

Within the detector 105, a microcontroller board 208 is provided along with a terminal block 209. The detector 105 further comprises a gas sensor 210 (e.g., a methane sensor), a pressure sensor 211, and a temperature/relative humidity sensor 212. A GSM module 213 and a real-time clock 214 are also provided in an implementation of the detector 105, although these are not intended to be limiting and one or both of the GSM module 213 and the real-time clock 214 may be optional in some implementations.

In an implementation, the detector 105 is controlled by the microcontroller board 208 (e.g., Uno WiFi Rev2, Arduino, etc.). The controlling program uploaded on the microcontroller board 208 is written to interact with sensors such as the gas sensor 210, the pressure sensor 211, and the temperature/relative humidity sensor 212, and manage communication (e.g., for the front-end in some implementations) through GSM and WiFi, for example. The communication network is not only intended for GSM and WiFi, but also can include ZigBee, LoRa, Bluetooth, or other types of wireless networks depending on the implementation and whether the communication is front-end communication, back-end communication, or a merging of the front-end communication and the back-end communication in some implementations. The detector 105 can be modified and adapt to the wireless technologies as needed. The sensors 210, 211, 212 may be mounted on a printed circuit board shield.

Among several metal oxide semiconductors, in an implementation, the gas sensor 210 may be the Figaro TGS 2611-E00 (Figaro USA Inc.) due to accuracy and suitability for detecting methane concentration levels in the atmosphere. Two 5V voltage regulators (such as MAX6350ESA+, Maxim Integrated and D24V10F5, Pololu) are assembled for sensor and heater of the TGS2611-E00 sensor, respectively. A 10 kΩ±1% resistor is connected in series to the sensor and the heater. Voltage across the resistor is read using an analog input. It converts to a resistance for methane concentration.

The gas sensor 210 (e.g., the TGS2611-E00 sensor) depends on temperature and relative humidity and these properties are monitored using a digital sensor as the temperature/relative humidity sensor 212 (such as SHT35-DIS-F2.5KS, Sensirion AG, in an implementation). The SHT35-DIS-F2.5KS sensor has typical accuracies of ±0.1° C. and ±1.5% rH. Pull-up 10 kΩ±1% resistors are connected to serial clock and serial data. A 100 nF capacitor is placed to suppress high-frequency noise in power supply signals.

Atmospheric pressure may influence gas migration. Atmospheric pressure is measured by the pressure sensor 211, which may be, for example in an implementation, a LPS25HB (STMicroelectronics) sensor with an accuracy of ±0.2 mbar.

In an implementation, a 3.3V regulator on the microcontroller board 208 provides power for both the pressure sensor 211 and the temperature/relative humidity sensor 212.

Sensor data are collected at a frequency of 1 Hz, time-stamped using the real-time clock 214, such as DS3231 AT24C32 IIC RTC Module, Diymore, for example in an implementation. In some implementations, the GSM module 213, such as MKR GSM 1400, Arduino, for example in an implementation, is used to communicate in the front-end or the back-end or both. A WiFi module integrated on the microcontroller board 208 is ready for communication in the front-end or the back-end or both, depending on the implementation.

In an implementation, the detector 105 may be housed in a weatherproofed plastic case that has dimensions of approximately 4 inches×4 inches×3 inches. Holes may be located at the side of the case to ensure air exchange across the sensors. The detector 105 may be powered by a wall-plug in 9V AC/DC adapter and/or 9V batteries in some implementations.

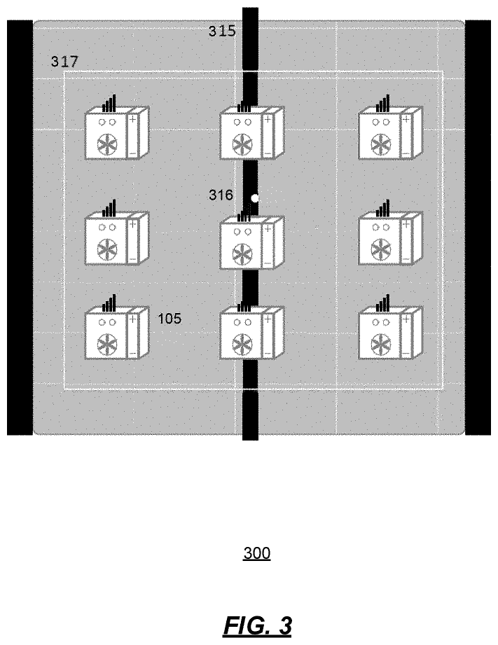

FIG. 3 is an illustration of a schematic diagram of an implementation of a real-time monitoring network 300 at a known leak area 317. Detectors 105 are deployed within a perimeter of the leak area 317. In an implementation, the detectors 105 are powered by batteries and monitor a non-hazardous gas leak 316 from a gas pipeline 315. The communication is established via the cellular data network to a cloud database such as the cloud database 120.

If the detector 105 is installed in multiple buildings served by a gas utility company, a detector network is established in a local area. Changes in methane concentrations from the detector network will aid the utility company to trace gas migration and track back to a leak location. The detector 105 can also be mounted outdoors to assist in finding leaks quicker. It may be installed in a location that are not susceptible to vibration. The detector 105 may be installed pointing downwards to ensure dust or water will not collect on the sensors therein and stop the gas entering the detector 105.

For outdoor applications, there is a need of installing a detector network at a known gas leak site. For non-hazardous leaks such as grade 2 and 3 leaks, there is a time gap of pipeline fixing from the time of leak detection. Multiple detectors powered by batteries may be placed around perimeter of the leak location to monitor any changes. The network configuration is flexible and adaptable as the situation demands. Different types of wireless communication (such as ZigBee, LoRa, Bluetooth, etc.) can be installed on the detector 105. A detector network coordinator (e.g., a user, an administrator, a computing device, etc.) manages each detector in the network. The coordinator closely watches the concentration levels when the network is placed in a high-risk area. The system can also include rechargeable batteries via a solar power cell.

The data gathered from the field (i.e., the detector(s) 105) are transmitted to a cloud database (e.g., the cloud database 120) by a network (e.g., the network 108 which may be a wireless network). The utility company (e.g., via the business computing device 160) notices and prioritizes a repair schedule if (or when) there are any changes in concentration levels. Additionally or alternatively depending on the implementation, the detector system (comprising one or more detectors 105) can be placed at the repaired locations to conduct a follow up inspection for assuring compliance. Only minimum supervision is required at the locations after the detector network is installed.

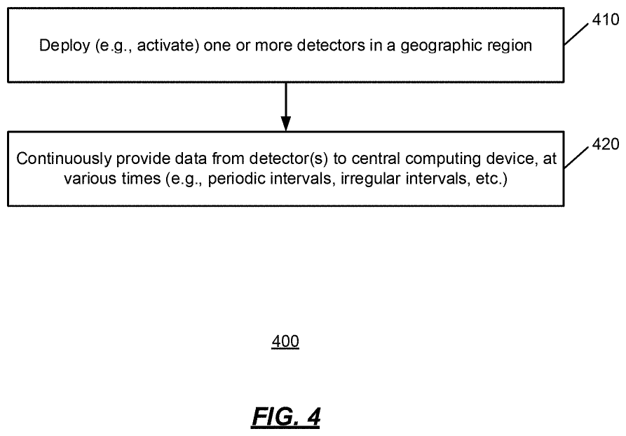

FIG. 4 is an operational flow of an implementation of a method 400 for gas leak detection and monitoring. The method 400 may be directed to provided sensor data from one or more detectors to a central computing device for real-time (and/or delayed) analysis for leak detection, identification, grading, remediation, compliance, etc. depending on the implementation.

At 410, one or more detectors are deployed (e.g., activated) in a geographic region. The detectors may be the detectors 105a, 105b, . . . , 105n, and the geographic region may be any area that is to be monitored for a gas leak, such as a methane gas leak.

At 420, each of the one or more detectors provides data to a computing device, such as a central computing device. The data may be sensor data (e.g., data from one or more of the sensors 210, 211, 212 of each detector 105). The data may be provided continuously, such as at various times of day, at periodic intervals, at irregular intervals, etc. The central computing device may receive this data and store it, e.g., in an associated cloud database such as the cloud database 120.

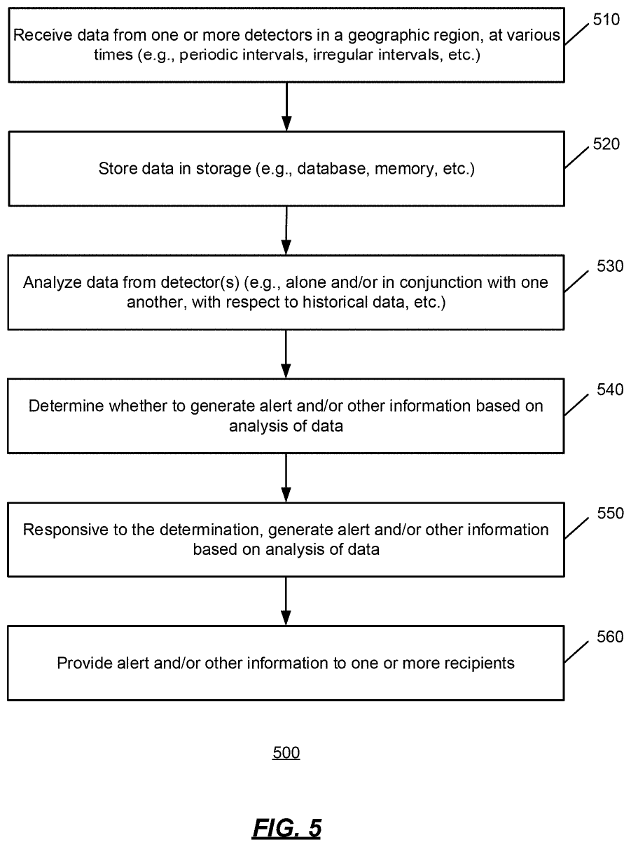

FIG. 5 is an operational flow of another implementation of a method 500 for gas leak detection and monitoring. The method 500 may be directed to receiving sensor data at a central computing device from one or more detectors for real-time (and/or delayed) analysis for leak detection, identification, grading, remediation, compliance, etc. depending on the implementation.

At 510, data from one or more gas detectors in a geographic region are received at a computing device, such as a central computing device. The detectors may be the detectors 105a, 105b, . . . , 105n, and the geographic region may be any area that is to be monitored for a gas leak, such as a methane gas leak. The data may be received continuously, such as at various times of day, at periodic intervals, at irregular intervals, etc.

At 520, the data is stored in storage associated with the computing device. The storage may be any type of storage device, database, memory, etc. In an implementation, the data is stored in a cloud database such as the cloud database 120.

At 530, the data received from the detector(s) are analyzed by the computing device (or a computing device associated with the storage comprising the stored data). The data from each detector may be analyzed alone and/or in conjunction with the data from one or more other detectors in the geographic region (e.g., that provide the data at 510). The data may be analyzed with respect to present data and/or historical data, depending on the implementation.

At 540, it is determined by the computing device whether to generate an alert and/or other information (e.g., take other action) based on the analysis of the data at 530. The alert and/or other information may comprise messages, signals, communications, indicators, and/or information about a leak and/or gas monitoring in the geographic region in which the detectors are deployed and providing data. Depending on the implementation, the alert and/or other information may be directed to leak detection, identification, grading, remediation, compliance, etc.

At 550, responsive to the determination at 540 indicating that an alert and/or other information is to be generated, the alert and/or other information is generated.

At 560, the alert and/or other information is provided to one or more recipients, such as the user computing device 130 (e.g., a computing device of a first responder), the computer 140, the smartphone 150 (e.g., of an occupant of a home or building), and/or the business computing device 160 (e.g., a computing device of a gas utility company). Appropriate action may then be taken, as necessary or as desired, by the recipient(s).

FIG. 6 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system comprises: a central computing device; and a plurality of gas detectors deployed in a geographic region, wherein each of the plurality of gas detectors is configured to sense real-time data and transmit the real-time data to the central computing device.

Implementations may include some or all of the following features. Each of the plurality of gas detectors comprises a gas sensor, a pressure sensor, a temperature/relative humidity sensor, and a Global Positioning System (GPS) chip, and wherein the real-time data comprises data based on sensed data from the gas sensor, sensed data from the pressure sensor, sensed data from the temperature/relative humidity sensor, and data from the GPS chip, wherein the location of each of the plurality of gas detectors is determined along with the time of day from the data from each GPS chip. Each of the plurality of gas detectors is a methane gas detector or a natural gas detector. The geographic region comprises a gas pipeline. The geographic region comprises an environment with a known existing leak or comprises a high-risk area. The plurality of gas detectors are further configured to continuously transmit the real-time data to the central computing device. The system further comprises a cloud database associated with the central computing device, wherein the cloud database is configured to store the real-time data. The central computing device is configured to receive the real-time data from the plurality of gas detectors and analyze the real-time data to determine whether to generate at least an alert or other information based on the real-time data. The at least the alert or other information is directed to at least one of leak detection, identification, grading, remediation, or compliance. The central computing device is further configured to analyze historical data with the real-time data to determine whether to generate the least the alert or other information. The central computing device is configured to generate at least an alert or other information based on the real-time data. The central computing device is further configured to provide the at least the alert or other information to at least one recipient. The at least one recipient comprises a computing device of a first responder, a computing device of an occupant of a home or building in the geographic region, or a computing device of a gas utility company.

In an implementation, a method comprises: deploying a plurality of gas detectors deployed in a geographic region, wherein the geographic region comprises a gas pipeline, an environment with a known existing leak, or a high-risk area; sensing real-time data with the plurality of gas detectors; and transmitting the real-time data to a central computing device.

Implementations may include some or all of the following features. Each of the plurality of gas detectors is a methane gas detector or a natural gas detector, and wherein each of the plurality of gas detectors comprises a gas sensor, a pressure sensor, and a temperature/relative humidity sensor, and wherein the real-time data comprises data based on sensed data from the gas sensor, sensed data from the pressure sensor, and sensed data from the temperature/relative humidity sensor. The plurality of gas detectors continuously transmit the real-time data to the central computing device at various times of day, at periodic intervals, or at irregular intervals.

In an implementation, a method comprises: receiving, over a network at a computing device, real-time data from a plurality of gas detectors deployed in a geographic region; storing the real-time data in storage associated with the computing device; analyzing the real-time data to determine whether to generate at least an alert or other information based on the real-time data; generating at least the alert or other information based on the real-time data, responsive to the analyzing; and providing the at least the alert or other information to at least one recipient.

Implementations may include some or all of the following features. Each of the plurality of gas detectors is a methane gas detector or a natural gas detector, and wherein the receiving the real-time data comprises continuously receiving the real-time data at various times of day, at periodic intervals, or at irregular intervals, and wherein the at least one recipient comprises a computing device of a first responder, a computing device of an occupant of a home or building in the geographic region, or a computing device of a gas utility company. The geographic region comprises a gas pipeline, an environment with a known existing leak, or a high-risk area, and wherein the at least the alert or other information is directed to at least one of leak detection, identification, grading, remediation, or compliance. Analyzing the real-time data further comprises analyzing historical data with the real-time data to determine whether to generate the least the alert or other information.

As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a central computing device; and
a plurality of gas detectors deployed in a geographic region, wherein each of the plurality of gas detectors is configured to sense real-time data and transmit the real-time data to the central computing device.

2. The system of claim 1, wherein each of the plurality of gas detectors comprises a gas sensor, a pressure sensor, a temperature/relative humidity sensor, and a Global Positioning System (GPS) chip, and wherein the real-time data comprises data based on sensed data from the gas sensor, sensed data from the pressure sensor, sensed data from the temperature/relative humidity sensor, and data from the GPS chip, wherein the location of each of the plurality of gas detectors is determined along with the time of day from the data from each GPS chip.

3. The system of claim 1, wherein each of the plurality of gas detectors is a methane gas detector or a natural gas detector.

4. The system of claim 1, wherein the geographic region comprises a gas pipeline.

5. The system of claim 1, wherein the geographic region comprises an environment with a known existing leak or comprises a high-risk area.

6. The system of claim 1, wherein the plurality of gas detectors are further configured to continuously transmit the real-time data to the central computing device.

7. The system of claim 1, further comprising a cloud database associated with the central computing device, wherein the cloud database is configured to store the real-time data.

8. The system of claim 1, wherein the central computing device is configured to receive the real-time data from the plurality of gas detectors and analyze the real-time data to determine whether to generate at least an alert or other information based on the real-time data.

9. The system of claim 8, wherein the at least the alert or other information is directed to at least one of leak detection, identification, grading, remediation, or compliance.

10. The system of claim 8, wherein the central computing device is further configured to analyze historical data with the real-time data to determine whether to generate the least the alert or other information.

11. The system of claim 1, wherein the central computing device is configured to generate at least an alert or other information based on the real-time data.

12. The system of claim 11, wherein the central computing device is further configured to provide the at least the alert or other information to at least one recipient.

13. The system of claim 12, wherein the at least one recipient comprises a computing device of a first responder, a computing device of an occupant of a home or building in the geographic region, or a computing device of a gas utility company.

14. A method comprising:
deploying a plurality of gas detectors deployed in a geographic region, wherein the geographic region comprises a gas pipeline, an environment with a known existing leak, or a high-risk area;
sensing real-time data with the plurality of gas detectors; and
transmitting the real-time data to a central computing device.

15. The method of claim 14, wherein each of the plurality of gas detectors is a methane gas detector or a natural gas detector, and wherein each of the plurality of gas detectors comprises a gas sensor, a pressure sensor, and a temperature/relative humidity sensor, and wherein the real-time data comprises data based on sensed data from the gas sensor, sensed data from the pressure sensor, and sensed data from the temperature/relative humidity sensor.

16. The method of claim 14, wherein the plurality of gas detectors continuously transmit the real-time data to the central computing device at various times of day, at periodic intervals, or at irregular intervals.

17. A method comprising:
receiving, over a network at a computing device, real-time data from a plurality of gas detectors deployed in a geographic region;
storing the real-time data in storage associated with the computing device;
analyzing the real-time data to determine whether to generate at least an alert or other information based on the real-time data;
generating at least the alert or other information based on the real-time data, responsive to the analyzing; and
providing the at least the alert or other information to at least one recipient.

18. The method of claim 17, wherein each of the plurality of gas detectors is a methane gas detector or a natural gas detector, and wherein the receiving the real-time data comprises continuously receiving the real-time data at various times of day, at periodic intervals, or at irregular intervals, and wherein the at least one recipient comprises a computing device of a first responder, a computing device of an occupant of a home or building in the geographic region, or a computing device of a gas utility company.

19. The method of claim 17, wherein the geographic region comprises a gas pipeline, an environment with a known existing leak, or a high-risk area, and wherein the at least the alert or other information is directed to at least one of leak detection, identification, grading, remediation, or compliance.

20. The method of claim 17, wherein analyzing the real-time data further comprises analyzing historical data with the real-time data to determine whether to generate the least the alert or other information.
